(19) United States
(12) Patent Application Publication
(10) Pub. No.: US 2021/0390284 A1
(43) Pub. Date: Dec. 16, 2021

(54) SYSTEM AND METHOD FOR IDENTIFYING OBJECTS PRESENT WITHIN A FIELD ACROSS WHICH AN AGRICULTURAL VEHICLE IS TRAVELING

(71) Applicant: CNH Industrial America LLC, New Holland, PA (US)

(72) Inventors: Kevin M. Smith, Narvon, PA (US); Luca Ferrari, Formigine (Modena) (IT); Aditya Singh, Bolingbrook, IL (US); Trevor Stanhope, Palos Hills, IL (US)

(73) Assignee: CNH Industrial America LLC

(21) Appl. No.: 17/340,411

(22) Filed: Jun. 7, 2021

Related U.S. Application Data
(60) Provisional application No. 63/037,690, filed on Jun. 11, 2020.

(51) Int. Cl. G06K 9/00; G06T 7/62; G06T 7/50; G06F 3/14; B60K 35/00; G05D 1/02; G01S 17/894

(52) U.S. Cl. CPC G06K 9/00201; G06K 9/00791; G06T 7/62; G06T 7/50; G06F 3/14; B60K 35/00; A01C 21/007; G01S 17/894; G06T 2207/10028; G06T 2207/30188; G06T 2207/30252; G05D 2201/0201; G05D 1/0212

(57) ABSTRACT

A system for identifying objects present within a field across which an agricultural vehicle is traveling includes a transceiver-based sensor configured to capture point cloud data associated with a portion of the field present within a field of view of the transceiver-based sensor as the agricultural vehicle travels across the field. Additionally, the system includes a display device and a controller communicatively coupled to the transceiver-based sensor and the display device. The controller, in turn, is configured to analyze the captured point cloud data to create a sparse point cloud identifying at least one of a crop row or a soil ridge located within the portion of the field present within the field of view of the transceiver-based sensor. Furthermore, the controller is configured to initiate display of an image associated with the sparse point cloud on the display device.

### CROSS-REFERENCE TO RELATED APPLICATIONS

This application is based upon and claims the right of priority to U.S. Provisional Patent Application No. 63/037,690, filed on Jun. 11, 2020, the disclosure of which is hereby incorporated by reference herein in its entirety for all purposes.

### FIELD OF THE INVENTION

The present disclosure generally relates to agricultural vehicles and, more particularly, to systems and methods for identifying objects, such as crop rows and/or soil ridges, present within a field across which an agricultural vehicle is traveling.

### BACKGROUND OF THE INVENTION

Agricultural sprayers apply an agricultural substance (e.g., a pesticide) onto crops as the sprayer is traveling across a field. To facilitate such travel, sprayers are configured as self-propelled vehicles or implements towed behind an agricultural tractor or other suitable agricultural vehicle. A typical sprayer includes one or more boom assemblies on which a plurality of spaced apart nozzles is mounted. Each nozzle is configured to dispense or otherwise spray the agricultural substance onto underlying crops and/or weeds.

Typically, a sprayer includes an imaging device that captures data for use in guiding the sprayer across the field during the spraying operation. For example, in certain instances, the imaging device may correspond to a camera. As such, the camera may capture images for use in guiding the sprayer across the field. Moreover, these captured images may be displayed to the operator of sprayer to allow the operator to visualize the objects (e.g., crop rows, soil ridges, obstacles, and the like) present within the field. However, when the imaging device corresponds to a transceiver-based sensor, such as a light detection and ranging (LIDAR) sensor, the data set captured by such sensor may be too large to transmit via the communicative links/protocols typically used by agricultural sprayers (e.g., CANBUS).

Accordingly, an improved system and method for identifying objects present within a field across which an agricultural vehicle is traveling would be welcomed in the technology. Specifically, a system and method for identifying objects present within a field across which an agricultural vehicle is traveling that allows data captured by a transceiver-based sensor to be analyzed and subsequently displayed to the operator would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for identifying objects present within a field across which an agricultural vehicle is traveling. The system includes a transceiver-based sensor configured to capture point cloud data associated with a portion of the field present within a field of view of the transceiver-based sensor as the agricultural vehicle travels across the field. Additionally, the system includes a display device and a controller communicatively coupled to the transceiver-based sensor and the display device. The controller, in turn, includes a processor and associated memory, with the memory storing instructions that, when implemented by the processor, configure the controller to analyze the captured point cloud data to create a sparse point cloud, the sparse point cloud identifying at least one of a crop row or a soil ridge located within the portion of the field present within the field of view of the transceiver-based sensor. Furthermore, the controller is configured to initiate display of an image associated with the sparse point cloud on the display device.

In another aspect, the present subject matter is directed to a method for identifying objects present within a field across which an agricultural vehicle is traveling. The method includes controlling, with one or more computing devices, an operation of the agricultural vehicle such that the agricultural vehicle travels across the field to perform an agricultural operation on the field. Additionally, the method includes receiving, with the one or more computing devices, captured point cloud data associated with a portion of the field as the agricultural vehicle travels across the field. Furthermore, the method includes analyzing, with the one or more computing devices, the captured point cloud data to create a sparse point cloud, the sparse point cloud identifying at least one of a crop row or a soil ridge present within the portion of the field. Moreover, the method includes initiating, with the one or more computing devices, display of an image associated with the sparse point cloud on the display device.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural vehicle in accordance with aspects of the present subject matter;

FIG. 2 illustrates a side view of the agricultural vehicle shown in FIG. 1, particularly illustrating various components thereof;

FIG. 3 illustrates a schematic view of one embodiment of a system for identifying objects present within a field across which an agricultural vehicle is traveling in accordance with aspects of the present subject matter;

FIG. 4 illustrates an example image associated with a plurality of identified crop rows that is displayed to the operator of an agricultural vehicle in accordance with aspects of the present subject matter; and

FIG. 5 illustrates a flow diagram of one embodiment of a method for identifying objects present within a field across which an agricultural vehicle is traveling in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for identifying objects present within a field across which an agricultural vehicle is traveling. Specifically, in several embodiments, a controller of the disclosed system may be configured to control the operation of an agricultural vehicle (e.g., a sprayer) such that the vehicle travels across the field to perform an agricultural operation (e.g., a spraying operation) thereon. As the vehicle travels across the field, the controller may be configured to receive point cloud data (e.g., three-dimensional point cloud data) captured by one or more transceiver-based sensors (e.g., a light detection and ranging (LIDAR) sensors) installed on the vehicle or an associated implement. The captured point could data may, in turn, be indicative of one or more objects present within and/or characteristics of the portion of the field present within the field(s) of view of the transceiver-based sensor(s).

In accordance with aspects of the present subject matter, the controller may be configured to initiate display of one or more images on a display device of the vehicle based on the captured point cloud data. More specifically, the point cloud data captured by the transceiver-based sensor(s) may be too large to transmit over the communicative links/protocols (e.g., the CANBUS) used by the sprayer. In this respect, the controller may be configured to analyze the captured point cloud data to create a sparse point cloud identifying one or more crop rows and/or soil ridges present within the field of view(s) of the transceiver-based sensor(s). The sparse point cloud may, in turn, be a simplified data set of the captured point that can be transmitted over the sprayer's communicative links. As such, in one embodiment, the sparse point cloud may be a two-dimensional representation of the three-dimensional captured point with associated metadata. In such an embodiment, the metadata may indicate the presence of crop rows and/or soil ridges within the field of view(s) of the transceiver-based sensor(s) and identify a characteristic(s) of such crop rows and/or soil ridges. Thereafter, the controller may be configured to initiate display of one or more images depicting or otherwise associated with the sparse point cloud. For example, when the sparse point cloud identifies the presence of a crop row, an image of a crop row stored within its memory may be displayed on the display screen.

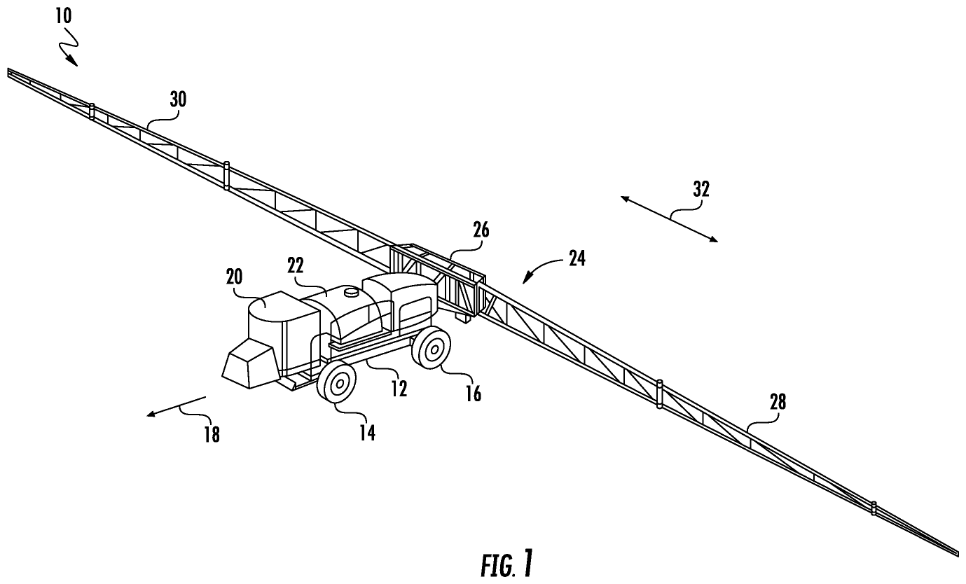

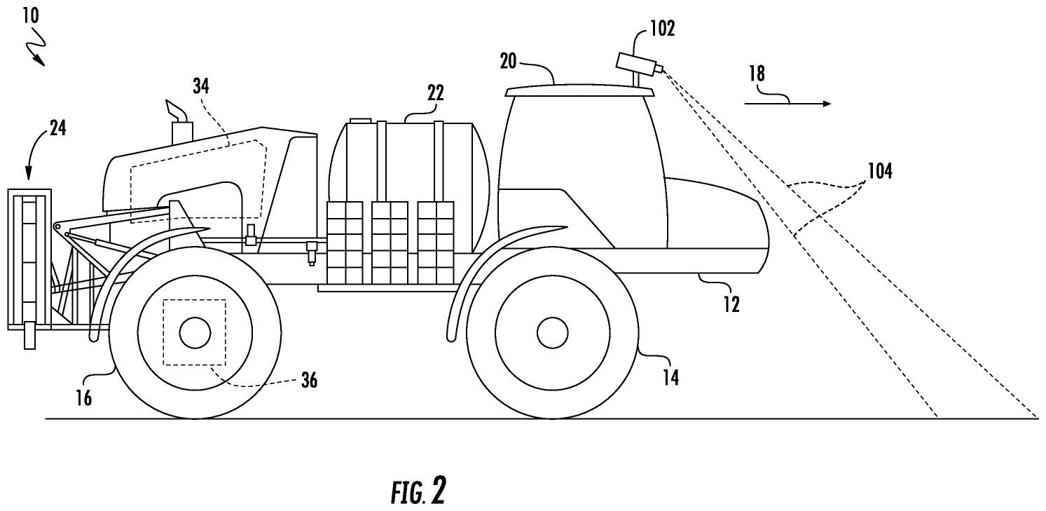

Referring now to the drawings, FIGS. 1 and 2 illustrate differing views of one embodiment of an agricultural vehicle 10 in accordance with aspects of the present subject matter. Specifically, FIG. 1 illustrates a perspective view of the agricultural vehicle 10. Additionally, FIG. 2 illustrates a side view of the agricultural vehicle 10, particularly illustrating various components of the agricultural vehicle 10.

In the illustrated embodiment, the agricultural vehicle 10 is configured as a self-propelled agricultural sprayer. However, in alternative embodiments, the agricultural vehicle 10 may be configured as any other suitable agricultural vehicle that travels across a field relative to one or more crop rows or soil ridges within the field. For example, in some embodiment, the agricultural vehicle 10 may be configured as an agricultural tractor (with or without an associated agricultural implement, such as a towable sprayer, a seed-planting implement, or a tillage implement), an agricultural harvester, and/or the like.

As shown in FIGS. 1 and 2, the agricultural vehicle 10 may include a frame or chassis 12 configured to support or couple to a plurality of components. For example, a pair of steerable front wheels 14 and a pair of driven rear wheels 16 may be coupled to the frame 12. The wheels 14, 16 may be configured to support the agricultural vehicle 10 relative to the ground and move the vehicle 10 in the direction of travel 18 across the field. Furthermore, the frame 12 may support an operator's cab 20 and a tank 22 configured to store or hold an agricultural fluid, such as a pesticide (e.g., a herbicide, an insecticide, a rodenticide, and/or the like), a fertilizer, or a nutrient. However, in alternative embodiments, the vehicle 10 may include any other suitable configuration. For example, in one embodiment, the front wheels 14 of the vehicle 10 may be driven in addition to or in lieu of the rear wheels 16.

Additionally, the vehicle 10 may include a boom assembly 24 mounted on the frame 12. As shown, in one embodiment, the boom assembly 24 may include a center boom section 26 and a pair of wing boom sections 28, 30 extending outwardly from the center boom 26 along a lateral direction 32. The lateral direction 32, in turn, extends perpendicular the direction of travel 18. In general, a plurality of nozzles (not shown) mounted on the boom assembly 24 may be configured to dispense the agricultural fluid stored in the tank 22 onto the underlying plants and/or soil. However, in alternative embodiments, the boom assembly 24 may include any other suitable number and/or configuration of boom sections.

Referring particularly to FIG. 2, the agricultural vehicle 10 may include one or more devices or components for adjusting the speed at which the vehicle 10 moves across the field in the direction of travel 18. Specifically, in several embodiments, the agricultural vehicle 10 may include an engine 34 and a transmission 36 mounted on the frame 12. In general, the engine 34 may be configured to generate power by combusting or otherwise burning a mixture of air and fuel. The transmission 36 may, in turn, be operably coupled to the engine 34 and may provide variably adjusted gear ratios for transferring the power generated by the engine power to the driven wheels 16. For example, increasing the power output by the engine 34 (e.g., by increasing the fuel flow to the engine 34) and/or shifting the transmission 36 into a higher gear may increase the speed at which the agricultural vehicle 10 moves across the field. Conversely, decreasing the power output by the engine 34 (e.g., by decreasing the fuel flow to the engine 34) and/or shifting the transmission 36 into a lower gear may decrease the speed at which the agricultural vehicle 10 moves across the field.

It should be further appreciated that the configuration of the vehicle 10 described above and shown in FIGS. 1 and 2 is provided only to place the present subject matter in an exemplary field of use. Thus, it should be appreciated that the present subject matter may be readily adaptable to any manner of vehicle configuration.

In accordance with aspects of the present subject matter, one or more transceiver-based sensors 102 may be installed on the vehicle 10 and/or an associated implement (not shown). In general, the transceiver-based sensor(s) 102 may be configured to capture point cloud data depicting one or more crop rows and/or soil ridges present within an associated field(s) of view (indicated by dashed lines 104) as the vehicle 10 travels across the field to perform an operation (e.g., a spraying operation) thereon. As will be described below, a controller may be configured to analyze the captured point cloud data to identify the crop row(s) and/or soil ridge(s) present within the field(s) of view 104 of the sensor(s) 102.

The transceiver-based sensor(s) 102 may generally correspond to any suitable sensing device(s) configured to emit output signals for reflection off objects (e.g., the crop rows and/or soil ridges) within an associated field of view 104 and receive or sense the return signals. For example, in several embodiments, each transceiver-based sensor 102 may correspond to a light detection and ranging (LIDAR) sensor configured to emit light/laser output signals for reflection off the objects present within its field of view 104. In such an embodiment, each transceiver-based sensor 102 may receive the reflected return signals and generate point cloud data based on the received return signal(s). The point cloud data may, in turn, include a plurality of data points, with each point indicative of the distance between the sensor 102 and the object off which one of the return signals is reflected. However, in alternative embodiments, the transceiver-based sensor(s) 102 may correspond to a radio detection and ranging (RADAR) sensor(s), an ultrasonic sensor(s), or any other suitable type of transceiver-based sensor(s).

The transceiver-based sensor(s) 102 may be installed at any suitable location(s) that allow the transceiver-based sensor(s) 102 to capture point cloud data depicting one or more crop rows and/or soil ridges within the field. For example, in the illustrated embodiment, a transceiver-based sensor 102 is mounted on the roof of the cab 20. In such an embodiment, the transceiver-based sensor 102 has a field of view 104 directed at a portion of the field in front of the vehicle 10 relative to the direction of travel 18. As such, the transceiver-based sensor 102 is able to capture point cloud data depicting the one or more crop rows or soil ridges positioned in front of the vehicle 10. However, in alternative embodiments, the transceiver-based sensor(s) 102 may be installed at any other suitable location(s), such as on the boom assembly 24. Additionally, any other suitable number of transceiver-based sensors 102 may be installed on the vehicle 10 or an associated implement (not shown), such as two or more transceiver-based sensors 102.

Referring now to FIG. 3, a schematic view of one embodiment of a system 100 for identifying objects present within a field across which an agricultural vehicle is traveling is illustrated in accordance with aspects of the present subject matter. In general, the system 100 will be described herein with reference to the agricultural vehicle 10 described above with reference to FIGS. 1 and 2. However, it should be appreciated by those of ordinary skill in the art that the disclosed system 100 may generally be utilized with agricultural vehicles having any other suitable vehicle configuration.

As shown in FIG. 3, the system 100 may include a controller 106 positioned on and/or within or otherwise associated with the vehicle 10. In general, the controller 106 may comprise any suitable processor-based device known in the art, such as a computing device or any suitable combination of computing devices. Thus, in several embodiments, the controller 106 may include one or more processor(s) 108 and associated memory device(s) 110 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 110 of the controller 106 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 110 may generally be configured to store suitable computer-readable instructions that, when implemented by the processor(s) 108, configure the controller 106 to perform various computer-implemented functions.

In addition, the controller 106 may also include various other suitable components, such as a communications circuit or module, a network interface, one or more input/output channels, a data/control bus and/or the like, to allow controller 106 to be communicatively coupled to any of the various other system components described herein (e.g., the engine 34, the transmission 36, and/or the transceiver-based sensor(s) 102). For instance, as shown in FIG. 3, a communicative link or interface 112 (e.g., a data bus) may be provided between the controller 106 and the components 34, 36, 102 to allow the controller 106 to communicate with such components 34, 36, 102 via any suitable communications protocol (e.g., CANBUS, Ethernet, and the like).

The controller 106 may correspond to an existing controller(s) of the vehicle 10, itself, or the controller 106 may correspond to a separate processing device. For instance, in one embodiment, the controller 106 may form all or part of a separate plug-in module that may be installed in association with the vehicle 10 to allow for the disclosed systems to be implemented without requiring additional software to be uploaded onto existing control devices of the vehicle 10.

Moreover, the functions of the controller 106 may be performed by a single processor-based device or may be distributed across any number of processor-based devices, in which instance such devices may be considered to form part of the controller 106. For instance, the functions of the controller 106 may be distributed across multiple application-specific controllers, such as an engine controller, a transmission controller, an implement controller, and/or the like.

Furthermore, the system 100 may also include a user interface 114. More specifically, as will be described below, the user interface 114 may be configured to display images to the operator of the vehicle 10 associated with the crop rows and/or the soil ridges identified by analyzing the point cloud data captured by the transceiver-based sensor(s) 102. As such, the user interface 114 may include one or more display screens or display devices 116 (e.g., an LCD screen(s)) configured to display the images. In this respect, the user interface 114 may be communicatively coupled to the controller 106 via the communicative link 112 to permit the data associated with the images to be transmitted from the controller 106 to the user interface 114. In some embodiments, the user interface 114 may also include other feedback devices (not shown), such as speakers, warning lights, and/or the like, configured to provide additional feedback from the controller 106 to the operator. In addition, the user interface 114 may include one or more input devices (not shown), such as touchscreens, keypads, touchpads, knobs, buttons, sliders, switches, mice, microphones, and/or the like, which are configured to receive user inputs from the operator. In one embodiment, the user interface 114 may be mounted or otherwise positioned within the operator's cab 20 of the vehicle 10. However, in alternative embodiments, the user interface 114 may mounted at any other suitable location.

In several embodiments, the controller 106 may be configured to control the operation of the agricultural vehicle 10 such that the vehicle 10 travels across the field to perform an agricultural operation on the field. Specifically, in one embodiment, the controller 106 may be configured to transmit control signals to one or more components (e.g., the engine 34 and/or the transmission 36) of the vehicle 10 (e.g., via the communicative link 112). The control signals may, in turn, instruct the component(s) of the vehicle 10 to operate such that the vehicle 10 travels across the field in the direction of travel 18 to perform an agricultural operation (e.g., a spraying operation) on the field.

Additionally, the controller 106 may configured to create a sparse point cloud identifying one or more crop rows and/or soil ridges present within the field as the vehicle 10 travels across the field. More specifically, as described above, one or more transceiver-based sensors 102 (e.g., a LIDAR sensor(s)) may be supported or installed on the vehicle 10. Each transceiver-based sensor(s) 102 may, in turn, capture point cloud data associated with a portion of the field present within its field of view 104. For example, in one embodiment, the captured point cloud data may be three-dimensional data (e.g., each data point may have X, Y, and Z coordinates). In this respect, as the vehicle 10 travels across the field to perform the agricultural operation thereon, the controller 106 may be configured to receive the captured point cloud data from the transceiver-based sensor(s) 102 (e.g., via the communicative link 112). The controller 106 may be configured to process/analyze the received point cloud data create the sparse point cloud identifying one or more crop rows and/or soil ridges present within the field(s) of view 104 of the transceiver-based sensor(s) 102. The sparse point cloud may, in turn, be a simplified data set or version of the captured point cloud that can be transmitted over the sprayer's communicative links. As such, in one embodiment, the sparse point cloud may be a two-dimensional representation of the three-dimensional captured point cloud (e.g., each data point may only have X and Y coordinates and associated metadata as described below). The controller 106 may be configured to use any suitable point cloud data or visual data processing techniques to create the sparse point cloud based on the received point cloud data.

Moreover, in several embodiments, when analyzing the captured point cloud to create the sparse point cloud, the controller 106 may be configured to determine additional information or metadata associated with the crop row(s) and/or the soil ridge(s) depicted in the captured point cloud. Specifically, in one embodiment, the controller 106 may be configured to process/analyze the received point cloud data to identify crop row(s) and/or the soil ridge(s) present within the field(s) of view of the transceiver-based sensor(s) 102 and determine the position of the identified crop row(s) and/or the soil ridge(s) relative to the vehicle 10. In some embodiments, the controller 106 may be configured to process/analyze the received point cloud data to determine one or more characteristics or parameters of the identified crop row(s) and/or the soil ridge(s). For example, when a crop row(s) is identified, the controller 106 may be configured to determine the height, volume, and/or canopy coverage of such row(s) and/or the distance/spacing between pairs of crop row(s). Similarly, when a soil ridge(s) is identified, the controller 106 may be configured to determine the height, width, residue coverage, and/or weed coverage of such soil ridge(s). In this respect, each data point of the sparse point cloud may include two-dimensional coordinates (e.g., X and Y coordinates) and associated metadata (e.g., whether the data point corresponds to a crop row or a soil ridge and one or more characteristics of the crop row/soil ridge, such as its height). However, in alternative embodiments, the controller 106 may be configured to determine any other suitable parameter(s)/characteristic(s) associated with the identified crop row(s) and/or the soil ridge(s) when creating the sparse point cloud.

In accordance with aspects of the present subject matter, the controller 106 may be configured to initiate display of one or more images associated with the sparse point cloud. In general, as described above, the transceiver-based sensor(s) 102 may be configured to capture point cloud data. Such point cloud data may generally be too large to be readily transmitted via CANBUS and other communicative links/protocols used by the sprayer 10. As such, the controller 106 may be configured to transmit the sparse point cloud to the display device(s) 116 (e.g., via the communicative link 112). Upon receipt of the transmitted data, the display device(s) 116 may be configured to display the image(s) associated with the crop row(s) and/or the soil ridge(s) identified by the sparse point.

The displayed image(s) may be a simplified image(s) or image-like representation(s) associated with the identified the crop row(s) and/or the soil ridge(s). In several embodiments, the displayed image(s) may not be generated from the received point cloud data. That is, in such embodiments, the displayed image(s) are not rendered or modeled based on the received point cloud data. Instead, the controller 106 may be configured to initiate display of an image(s) (e.g., image(s) from an library stored within its memory device(s) 110) depicting the identified crop row(s)/soil ridge(s) in a manner that allows the operator to easily identify the row(s)/ridge(s) displayed on the display device(s) 116. For example, when a crop row is identified within the received data point cloud, the controller 106 may be configured to initiate display of a simplified image (e.g., a pictogram) of a crop row on the display device(s) 116.

Displaying a simplified image based on the sparse point cloud (as opposed to a rendered three-dimensional surface(s) of the captured point cloud data or images/video captured by a separate camera) reduces the amount of bandwidth necessary to transmit data from the controller 106 for display on the display device(s) 116. More specifically, CANBUS and other communications protocols typically used by agricultural vehicles have limited bandwidth. As such, these protocols may not allow for a rendered three-dimensional surface(s) of the captured point cloud data (or images/video captured by a camera) to be transmitted from the controller 106 to the display device(s) 116 in real-time. As such, displaying a simplified image of identified crop row(s) and/or soil ridge(s) based on the sparse point cloud may allow the operator to better visualize the crop row(s) and/or soil ridge(s) present within the field (e.g., better than with bar graphs), while still allowing CANBUS and/or other low bandwidth communication protocols to be used. As such, the displayed image(s) may include sufficient detail to allow the operator to easily recognize the displayed image(s) as either a crop row or a soil ridge, but not so much detail to prevent transmission via CANBUS and/or other low bandwidth communication protocols.

Furthermore, in several embodiments, the displayed image(s) may include the metadata/additional information associated with the identified the crop row(s) and/or the soil ridge(s) from the sparse cloud. Specifically, in some embodiments, the displayed image(s) may depict location(s) of the identified crop row(s) and/or soil ridge(s) relative to the vehicle 10. For example, in such embodiments, the displayed image(s) of the crop row(s) and/or soil ridge(s) may be in a first-person view in which the crop row(s) and/or soil ridge(s) are depicted as viewed by the transceiver-based sensor(s) 102. Alternatively, the displayed image(s) of the crop row(s) and/or soil ridge(s) may be in a third-person view in which a graphic of the vehicle 10 is overlaid on the displayed image(s) of the crop row(s) and/or soil ridge(s), thereby providing an indication of the location(s) of the identified crop row(s) and/or soil ridge(s) relative to the vehicle 10. Additionally, in some embodiments, the displayed image(s) may depict the determined characteristics of the identified crop row(s) and/or soil ridge(s). For example, the displayed image(s) may include a flag(s), a text box(es), a scale(s), and/or the like that indicates the determined characteristics of the identified crop row(s) and/or soil ridge(s).

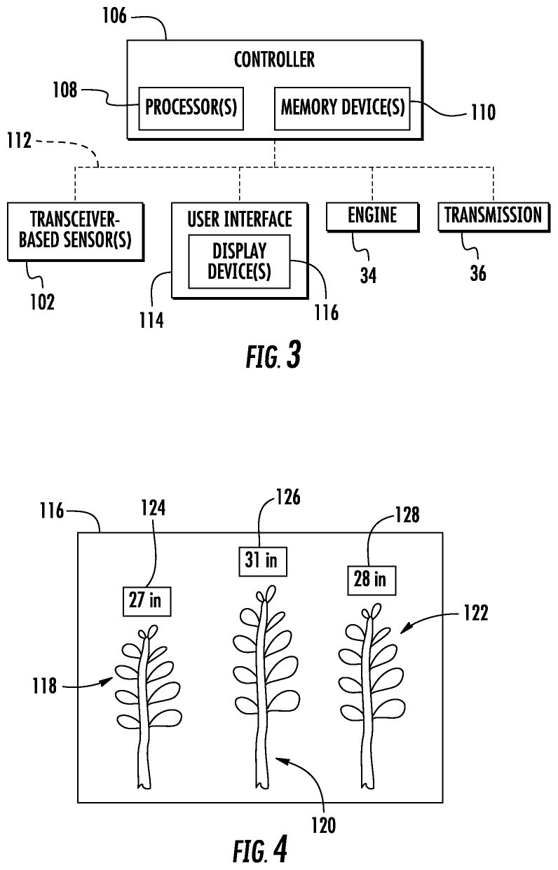

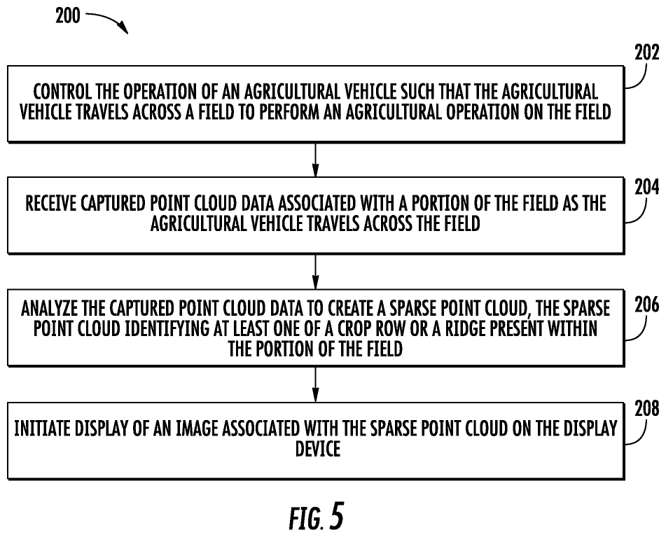

Referring now to FIG. 4, an example image associated with a plurality identified crop rows that is displayed to the operator of the agricultural vehicle 10 is illustrated in accordance with aspects of the present subject matter. More specifically, the example image depicts a first-person view of a first crop row 118, a second crop row 120, and a third crop 122. As shown, the depictions of the crop rows 118, 120, 122 are sufficiently detailed to allow the operator to readily discern the crop rows 118, 120, 122. For example, the crop row depictions include a stalk and leaves of a plant, with the plant indicating the location of a crop row. Moreover, the plants are positioned on the display device 116 such that the locations of the crop rows 118, 120, 122 relative to the vehicle 10 are illustrated in a first-person view. However, the depicted plants are not exact images of the crop rows 118, 120, 122. For instance, the arrangement of the leaves on the stalks depicting the crop rows 118, 120, 122 are different in the displayed image than in actual crop rows within the field. Furthermore, the image includes a first text box 124 identifying the height of the first crop row 118, a second text box 126 identifying the height of the second crop row 120, and a third text box 126 identifying the height of the third crop row 122.

Referring again to FIG. 3, as indicated above, the displayed image(s) may be from a library of images stored with the memory device(s) 110 of the controller 106. For example, in several embodiments, the library stored in the memory device(s) 110 may include an image of a crop row and an image of a soil ridge. In such embodiments, when the controller 106 identifies a crop row based on the captured data point cloud, the controller 106 may retrieve the image of a crop row, modify the image as necessary (e.g., scale the image based on the size of the crop row and/or add the flag(s)/text box(es)/scales to the image), and transmit the modified image to the display device(s) 116. When the controller 106 identifies a soil ridge based on the captured data point cloud, the controller 106 may be perform similar operations on the stored image of the soil ridge. In alternative embodiments, any other suitable number of crop row images and/or soil ridge images may be stored within the memory device(s) 110 of the controller 106. Additionally, the displayed image(s) may be accessed from any other suitable location, such as a remote database server.

Additionally, the controller 106 may be configured to determine a confidence value associated with the identification of each data point in the sparse cloud as a crop row and/or a soil ridge. In general, the determined confidence value(s) may provide an indication (e.g., via a numerical value(s)) of the certainty or confidence that the identification of the crop row(s) and/or soil ridge(s) by the controller 106 is correct. For example, a high confidence value may indicate high level of certainty in the identification of the crop row(s), while a low confidence value may indicate high level of certainty in the identification of the crop row(s) and/or soil ridge(s). As such, the controller 106 may be configured to use any suitable statistical analysis techniques to determine the confidence value of each identified crop row or soil ridge. Such confidence value(s) may be part of the metadata of the sparse point cloud.

Moreover, in several embodiments, the controller 106 may be configured to adjust one or more parameters of the displayed image(s), such as the texture, hue, saturation, and/or the like, based on the determined confidence value(s). Such image parameter adjustments may indicate the level of certainty in the identification of the crop row(s) and/or soil ridge(s) depicted in the image(s) by the controller 106. For example, in one embodiment, the controller 106 may be configured to adjust the texture of the displayed image such that any crop rows and/or soil ridges depicted therein that were identified with a low level of certainty are blurry or fuzzy. Conversely, in such an embodiment, any crop rows and/or soil ridges depicted in the displayed image that were identified with a high level of certainty may have a clear texture. However, in alternative embodiments, the controller 106 may be configured to adjust the parameters of the displayed image(s) based on the determined confidence value(s) in any other suitable manner.

Referring now to FIG. 5, a flow diagram of one embodiment of a method 200 for identifying objects present within a field across which an agricultural vehicle is traveling is illustrated in accordance with aspects of the present subject matter. In general, the method 200 will be described herein with reference to the agricultural vehicle 10 and the system 100 described above with reference to FIGS. 1-4. However, it should be appreciated by those of ordinary skill in the art that the disclosed method 200 may generally be implemented with any agricultural vehicle having any suitable vehicle configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include controlling, with one or more computing devices, the operation of an agricultural vehicle such that the agricultural vehicle travels across a field to perform an agricultural operation on the field. For instance, as described above, the controller 106 may be configured to may be configured to control the operation of one or more components of the agricultural vehicle 10 (e.g., the engine 34 and/or the transmission 36) such that the vehicle 10 travels across a field to perform an agricultural operation (e.g., a spraying operation) on the field.

Additionally, at (204), the method 200 may include receiving, with the one or more computing devices, captured point cloud data associated with a portion of the field as the agricultural vehicle travels across the field. For instance, as described above, the controller 106 may be configured to receive captured point cloud data associated with a portion of the field from one or more transceiver-based sensor(s) as the agricultural vehicle 10 travels across the field.

Moreover, as shown in FIG. 5, at (206), the method 200 may include analyzing, with the one or more computing devices, the captured point cloud data to create a sparse point cloud identifying at least one of a crop row or a soil ridge present within the portion of the field. For instance, as described above, the controller 106 may be configured to analyze the captured point cloud data to create a sparse point cloud identifying a crop row and/or a soil ridge present within the portion of the field.

Furthermore, at (208), the method 200 may include initiating, with the one or more computing devices, display of an image associated with the sparse point cloud on the display device. For instance, as described above, the controller 106 may be configured to initiate display of an image associated with the sparse point cloud on the display device(s) 116 of the user interface 114.

It is to be understood that the steps of the method 200 are performed by the controller 106 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 106 described herein, such as the method 200, is implemented in software code or instructions which are tangibly stored on a tangible computer readable medium. The controller 106 loads the software code or instructions via a direct interface with the computer readable medium or via a wired and/or wireless network. Upon loading and executing such software code or instructions by the controller 106, the controller 106 may perform any of the functionality of the controller 106 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for identifying objects present within a field across which an agricultural vehicle is traveling, the system comprising:
a transceiver-based sensor configured to capture point cloud data associated with a portion of the field present within a field of view of the transceiver-based sensor as the agricultural vehicle travels across the field;
a display device; and
a controller communicatively coupled to the transceiver-based sensor and the display device, the controller including a processor and associated memory, the memory storing instructions that, when implemented by the processor, configure the controller to:
analyze the captured point cloud data to create a sparse point cloud, the sparse point cloud identifying at least one of a crop row or a soil ridge located within the portion of the field present within the field of view of the transceiver-based sensor; and
initiate display of an image associated with the sparse point cloud on the display device.

2. The system of claim 1, wherein the captured point cloud comprises three-dimensional data and the sparse point cloud comprises two-dimensional data.

3. The system of claim 1, wherein the sparse point cloud provides an indication of a location of the identified at least one of the crop row or the soil ridge relative to agricultural vehicle.

4. The system of claim 1, wherein, when analyzing the captured point cloud data, the controller is further configured to determine a characteristic associated with the at least one of the crop row or the soil ridge, the sparse point cloud including the determined characteristic.

5. The system of claim 4, wherein the identified at least one of the crop row or the soil ridge comprises a plurality of crop rows, the characteristic comprising at least one of a height of, a volume of, a canopy coverage of, or a spacing between the plurality of crop rows.

6. The system of claim 4, wherein the identified at least one of the crop row or the soil ridge comprises the soil ridge, the characteristic comprising at least one of a height, a width, a residue coverage, or a weed coverage of the soil ridge.

7. The system of claim 1, wherein, when initiating display of the image, the controller is further configured to transmit the sparse point cloud to the display device.

8. The system of claim 1, wherein, when analyzing the captured point cloud data, the controller is further configured to determine a confidence value associated with the identified at least one of the crop row or the soil ridge, the sparse point cloud including the determined confidence value.

9. The system of claim 8, wherein the controller is further configured to adjust a parameter of the displayed image based on the determined confidence value.

10. The system of claim 9, wherein the parameter comprises at least one of a texture, a hue, or a saturation of the displayed image.

11. The system of claim 1, wherein the image is retrieved from the memory of the controller.

12. The system of claim 1, wherein the agricultural vehicle comprises a sprayer.

13. A method for identifying objects present within a field across which an agricultural vehicle is traveling, the method comprising:
controlling, with one or more computing devices, an operation of the agricultural vehicle such that the agricultural vehicle travels across the field to perform an agricultural operation on the field;
receiving, with the one or more computing devices, captured point cloud data associated with a portion of the field as the agricultural vehicle travels across the field;
analyzing, with the one or more computing devices, the captured point cloud data to create a sparse point cloud, the sparse point cloud identifying at least one of a crop row or a soil ridge present within the portion of the field; and
initiating, with the one or more computing devices, display of an image associated with the sparse point cloud on the display device.

14. The method of claim 13, wherein the captured point cloud comprises three-dimensional data and the sparse point cloud comprises two-dimensional data.

15. The method of claim 13, wherein the sparse point cloud provides an indication of a location of the identified at least one of the crop row or the soil ridge relative to agricultural vehicle.

16. The method of claim 13, wherein analyzing the captured point cloud data comprises determining, with the one or more computing devices, a characteristic associated with the at least one of the crop row or the soil ridge, the sparse point cloud including the determined characteristic.

17. The method of claim 16, wherein the identified at least one of the crop row or the soil ridge comprises a plurality of crop rows, the characteristic comprising at least one of a height of, a volume of, a canopy coverage of, or a spacing between the plurality of crop rows.

18. The method of claim 16, wherein the identified at least one of the crop row or the soil ridge comprises the soil ridge, the characteristic comprising at least one of a height, a width, a residue coverage, or a weed coverage of the soil ridge.

19. The method of claim 13, wherein initiating display of the image comprises transmitting, with the one or more computing devices, the sparse point cloud to the display device.

20. The method of claim 13, further comprising:
wherein analyzing the captured point cloud data comprises determining, with the one or more computing devices, a confidence value associated with the identified at least one of the crop row or the soil ridge.
